(19) United States
(12) Patent Application Publication
(10) Pub. No.: US 2023/0375960 A1
(43) Pub. Date: Nov. 23, 2023

(54) TONER CARTRIDGE

(71) Applicant: Toshiba Tec Kabushiki Kaisha, Tokyo (JP)

(72) Inventor: Kohei SUGIHARA, Izunokuni Shizuoka (JP)

(21) Appl. No.: 18/157,602

(22) Filed: Jan. 20, 2023

(30) Foreign Application Priority Data
May 19, 2022 (JP) 2022-082341

(51) Int. Cl. G03G 15/08

(52) U.S. Cl. CPC G03G 15/0889

(57) ABSTRACT

A toner cartridge for storing toner to be supplied to an image forming apparatus, includes a container in which the toner is stored and including an opening through which the toner is discharged, a paddle including a plurality of scrapers and configured to rotate inside the container to stir the toner therein, and an auger including a screw blade and configured to rotate inside the container to feed the toner towards the opening. Each of the scrapers is deformable and extends away from the paddle with respect to a rotation axis of the paddle to contact the auger or an inner wall of the container when the paddle rotates.

### CROSS-REFERENCE TO RELATED APPLICATION(S)

This application is based upon and claims the benefit of priority from Japanese Patent Application No. 2022-082341, filed May 19, 2022, the entire contents of which are incorporated herein by reference.

### FIELD

Embodiments described herein relate generally to a toner cartridge and an image forming apparatus.

### BACKGROUND

In recent years, there have been many studies on a method of reducing the residual amount of toner in a used toner cartridge.

A conventional technique for reducing the residual amount includes using a toner cartridge having a bottle shape so that the residual amount of toner therein can be detected more accurately.

### SUMMARY OF THE INVENTION

Embodiments of the present invention provide a toner cartridge having a small residual amount of toner after use.

In one embodiment, a toner cartridge for storing toner to be supplied to an image forming apparatus, includes a container in which the toner is stored and including an opening through which the toner is discharged, a paddle including a plurality of scrapers and configured to rotate inside the container to stir the toner therein, and an auger including a screw blade and configured to rotate inside the container to feed the toner towards the opening. Each of the scrapers is deformable and extends away from the paddle with respect to a rotation axis of the paddle to contact the auger or an inner wall of the container when the paddle rotates.

### BRIEF DESCRIPTION OF THE DRAWINGS

FIG. 1 is a diagram of a configuration of a digital multifunction peripheral (MFP) according to an embodiment.

FIG. 2 is a schematic diagram of an image forming unit shown in FIG. 1.

FIG. 3 is an exploded perspective view of a toner cartridge.

FIG. 4 is a horizontal cross-sectional view of the toner cartridge in a state in which a scraping member is positioned above an auger.

FIG. 5 is a vertical cross-sectional view of the toner cartridge with the scraping member when a paddle rotates away from an inner wall of the toner container.

FIG. 6 is a vertical cross-sectional view of the toner cartridge in a state after the state of FIG. 5 where the scraping member hits the inner wall of a toner container in accordance with the rotation of the paddle.

FIG. 7 is a vertical cross-sectional view of the toner cartridge with the scraping member when the paddle rotates away from the inner wall of the toner container after the state of FIG. 6.

FIG. 8 is a vertical cross-sectional view of the toner cartridge in a state after the state of FIG. 7 where the scraping member hits the inner wall of the toner container in accordance with the rotation of the paddle.

### DETAILED DESCRIPTION

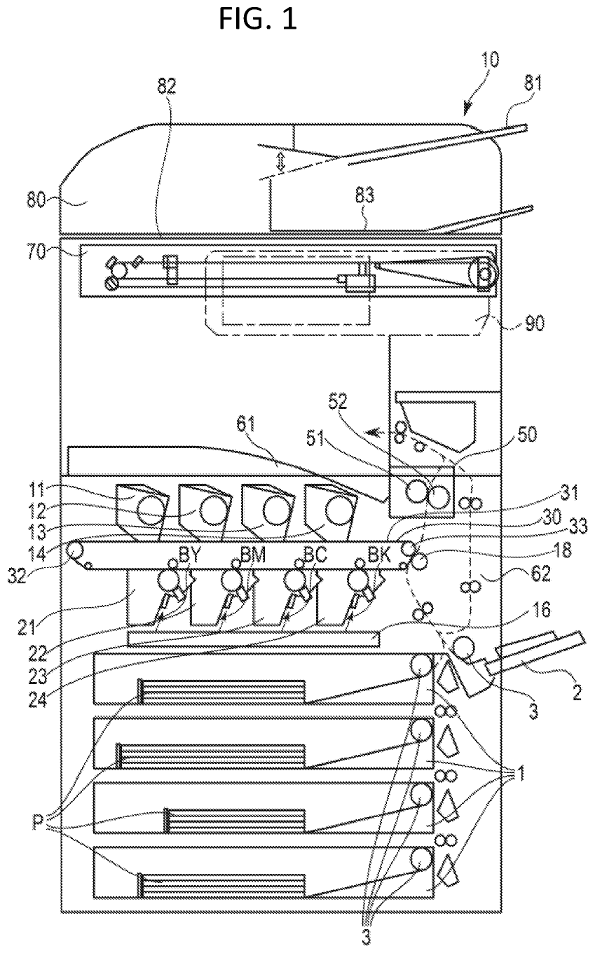

Hereinafter, embodiments will be described with reference to the drawings. First, with reference to FIG. 1, a digital multifunction peripheral 10 which is an example of an image forming apparatus using a toner cartridge according to an embodiment will be described. FIG. 1 is a diagram of a configuration of the digital multifunction peripheral 10.

The digital multifunction machine 10 has a printing function, a scanning function, a copying function, a facsimile function, etc. The printing function is a function of forming a toner image on a sheet P. The scanning function is a function of reading an image from a document. The copying function is a function of printing the image read from a document using the scanning function on a sheet P using the printing function. The facsimile function is a function of printing an image based on data received using a communication line on a sheet P using the printing function.

The digital multifunction peripheral 10 includes a plurality of sheet feed cassettes 1, a manual feed tray 2, and a plurality of sheet feed rollers 3. The sheet feed cassette 1 stores a plurality of sheets P used for printing. The manual feed tray 2 is used for manual feed in a state in which a plurality of sheets P are stacked. The sheet feed roller 3 takes out the sheets P stored in the sheet feed cassette 1 or placed on the manual feed tray 2 one by one.

The digital multifunction peripheral 10 includes a plurality of image forming units 21, 22, 23, and 24, an exposure device 16, a transfer belt unit 30, and a secondary transfer roller 18. Further, the digital multifunction peripheral 10 includes a plurality of toner cartridges 11, 12, 13, and 14 for supplying toner to the plurality of image forming units 21, 22, 23, and 24, respectively.

The toner cartridges 11, 12, 13, and 14 contain toners of respective colors to be supplied to the image forming units 21, 22, 23, and 24. The left-most toner cartridge 11 in FIG. 1 contains yellow toner. The second toner cartridge 12 from the left contains toner of magenta. The third toner cartridge 13 contains cyan toner. The rightmost toner cartridge 14 contains black toner. The toner cartridges 11, 12, 13, and 14 have substantially the same configuration except for the difference in the contained toner.

Herein, the term “toner” is used in a broad sense to mean both toner alone and a mixture of toner and carrier.

The image forming units 21, 22, 23, and 24 receive toner supplied from the toner cartridges 11, 12, 13, and 14, respectively, to form toner images of different colors. The leftmost image forming unit 21 in FIG. 1 forms a yellow (Y) toner image. The second image forming unit 22 from the left forms a toner image of magenta (M) color. The third image forming unit 23 from the left forms a cyan (C) toner image. The rightmost image forming unit 24 forms a black (K) toner image.

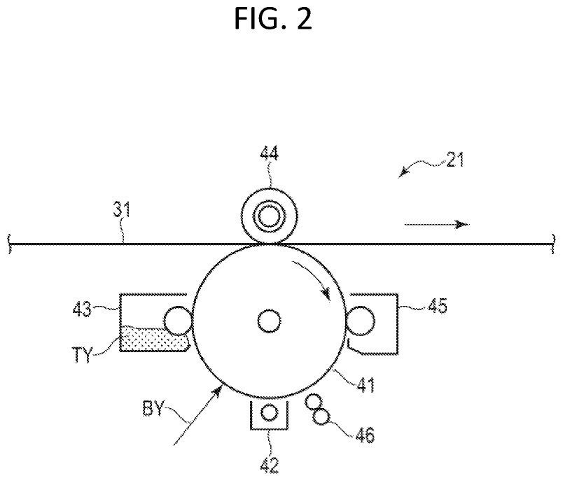

The image forming units 21, 22, 23, and 24 have substantially the same configuration except for the difference in toner. Therefore, here, referring to FIG. 2, the image forming unit 21 that forms a yellow toner image will be described, and the description of the image forming units 22, 23, and 24 that form toner images of other colors will be omitted.

As illustrated in FIG. 2, the image forming unit 21 includes a photoconductor drum 41, a charging unit 42, a developing device 43, a primary transfer roller 44, a cleaner 45, and a charge eliminating lamp 46.

The photoconductor drum 41 has a cylindrical surface that receives light beams BY emitted from the exposure device 16. The light beam BY is emitted based on image data read from a document by a scanner 70, which will be described later, or yellow image data obtained by color-separating the image data input from the outside of the digital multifunction peripheral 10. The exposure device 16 exposes and scans the surface of the photoconductor drum 41 with light-beam BY as the photoconductor drum 41 rotates, and forms an electrostatic latent image based on yellow image data on the surface of the photoconductor drum 41.

The charging unit 42 charges the surface of the photoconductor drum 41 before exposure to a predetermined potential. The developing device 43 develops the electrostatic latent image on the surface of the photoconductor drum 41 by a toner TY supplied from the toner cartridge 11. The developing device 43 forms a yellow toner image on the surface of the photoconductor drum 41.

The primary transfer roller 44 faces the surface of the photoconductor drum 41 with a transfer belt 31 of the transfer belt unit 30 interposed therebetween. The primary transfer roller 44 generates a transfer voltage between itself and the photoconductor drum 41. By this transfer voltage, the primary transfer roller 44 transfers the yellow toner image formed on the surface of the photoconductor drum 41 to the surface of the transfer belt 31 in contact with the photoconductor drum 41, which is referred to as primary transfer.

The cleaner 45 removes the toner TY remaining on the photoconductor drum 41. The charge eliminating lamp 46 removes the charge remaining on the surface of the photoconductor drum 41.

The exposure device 16 shown in FIG. 1 irradiates the photoreceptor drums 41 of the image forming units 21, 22, 23, and 24 with light-beam BY, BM, BC, BK in accordance with the color-separated image data of the respective colors. The light-beam BY, BM, BC, BK is for forming yellow, magenta, cyan, and black images, respectively.

The exposure device 16 controls the light-beam BY according to Y-component of the image data to form a yellow electrostatic latent image on the photoconductor drum 41 of the image forming unit 21. Similarly, the exposure device 16 controls the light-beam BM, BC, BK according to M, C, and K components of the image data to form electrostatic latent images for magenta, cyan, and black on the surfaces of the photosensitive drums 41 of the image forming units 22, 23, and 24.

The transfer belt unit 30 includes an endless transfer belt 31 and two rollers around which the transfer belt 31 is wound. These two rollers are a driven roller 32 and a drive roller 33. In addition, the transfer belt unit 30 includes a tension roller for applying tension to the transfer belt 31. By rotating the drive roller 33, the transfer belt 31 can rotate in both the forward and reverse directions. The transfer belt 31 rotates in the forward direction, which is the counterclockwise direction in FIG. 1, to convey the toner images of the respective colors transferred from the image forming units 21, 22, 23, and 24 to the secondary transfer roller 18.

The secondary transfer roller 18 faces the surface of the drive roller 33 with the transfer belt 31 interposed therebetween, and generates a transfer voltage with respect to the drive roller 33. The secondary transfer roller 18 transfers the toner images of the respective colors transferred onto the surface of the transfer belt 31 by the transfer voltage onto the sheet P conveyed between the transfer belt 31 and the secondary transfer roller 18, which is referred to as secondary transfer.

The digital multifunction peripheral 10 also includes a fixing device 50. The fixing device 50 heats and pressurizes the sheet P on which the toner images of the respective colors have been transferred. As a result, the toner images of the respective colors transferred to the sheet P are fixed to the sheet P. The fixing device 50 includes a heating roller 51 and a pressing roller 52 that face each other with the conveyance path of the sheet P interposed therebetween.

The heating roller 51 includes a heat source for heating the heating roller 51. The heat source is, for example, a heater. The heating roller 51 heated by the heat source heats the sheet P to the melting temperature of the toner. The pressing roller 52 presses the sheet P passing between the pressing roller 52 and the heating roller 51.

The digital multifunction peripheral 10 also includes a sheet discharge tray 61, a duplex unit 62, the scanner 70, a document feeder 80, and a control panel 90.

The sheet discharge tray 61 receives the sheet P discharged after the printing is completed. The duplex unit 62 brings the sheet P into a state in which printing on the back surface is possible. For example, the duplex unit 62 reverses the front and back sides of the sheet P by switching back the sheet P using a roller or the like.

The scanner 70 reads an image from a document. The scanner 70 reads an image by an optical reduction method including an image sensor such as an image sensor (CCD (charge-coupled device), for example. Alternatively, the scanner 70 reads an image using a close contact sensor (CIS (contact image sensor)) method including an image sensor such as an image sensor (CMOS (complementary metal-oxide-semiconductor).

The document feeder 80 is also referred to as an ADF (auto document feeder), for example. The document feeder 80 conveys the documents placed on a tray 81 one by one to a sheet discharge tray 83 through a document glass 82. The scanner 70 reads an image of a document passing over the document glass 82.

The control panel 90 includes buttons, a touch panel, and the like for an operator of the digital multifunction peripheral 10 to operate. The touch panel is, for example, a stack of a display such as a liquid crystal display or an organic EL display and a pointing device. Therefore, the button and the touch panel function as an input device that accepts an operation by the operator of the digital multifunction peripheral 10. The display of the touch panel functions as a display device that notifies the operator of the digital multifunction peripheral 10 of various kinds of information.

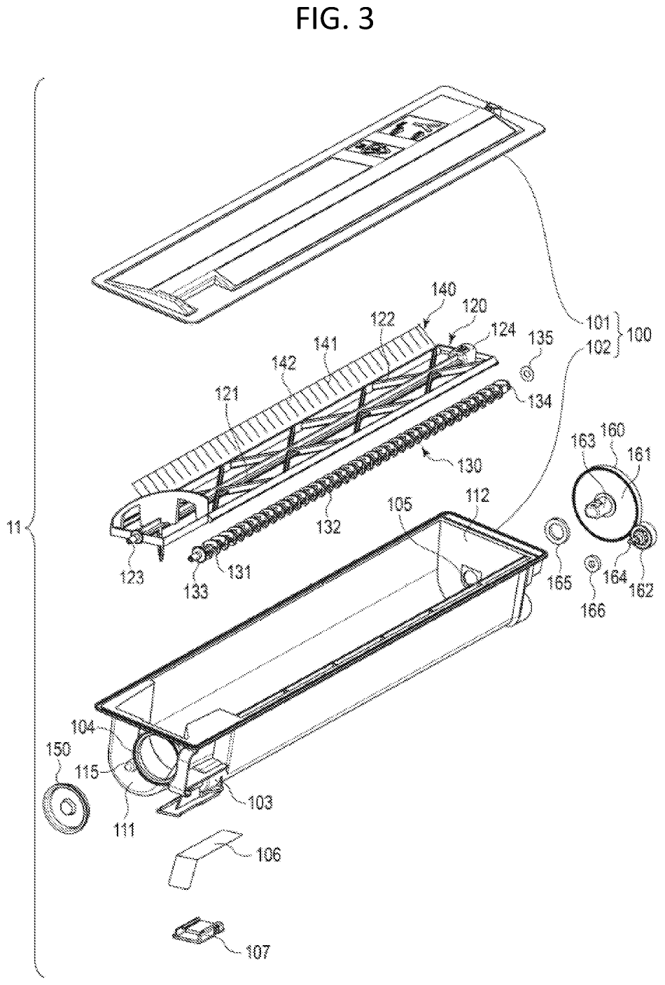

As described above, the toner cartridges 11, 12, 13, and 14 have substantially the same configuration except for the difference in the stored toners. Hereinafter, the configuration of the toner cartridge 11 will be described with reference to FIG. 3. FIG. 3 is an exploded perspective view of the toner cartridge 11. In the following description, the terms indicating positions such as “front”, “back”, and “horizontal” are based on the state of the toner cartridge 11 after it has been loaded in the digital multifunction peripheral 10.

The toner cartridge 11 includes a toner container 100, a paddle 120, an auger 130, and a scraping member 140.

The toner container 100 includes a container body 102 and a lid 101. The container body 102 has a substantially U-shape in a cross section perpendicular to the longitudinal direction of the toner container 100. The container body 102 has a front wall 111 perpendicular to the longitudinal direction at the front end thereof in the longitudinal direction, and has a back wall 112 perpendicular to the longitudinal direction at the back end thereof in the longitudinal direction. The lid 101 closes an opening above the container body 102. The lid 101 has an upwardly convex roof shape. The toner container 100 has an elongated box shape.

The container body 102 of the toner container 100 has a toner discharge portion 103 for discharging toner at one end portion of the container body 102, that is, a lower portion on its front side. The toner discharge portion 103 is for supplying toner to the image forming unit 21. The toner discharging portion 103 has an opening (not shown) opened downward. The container body 102 also includes a seal sheet 106 that seals the opening of the toner discharge portion 103, and a shutter 107 that opens and closes the opening of the toner discharge portion 103. The seal sheet 106 is peeled off when the toner cartridge 11 is in use. The shutter 107 moves and opens the opening of the toner discharging portion 103 when the toner cartridge 11 is loaded.

The front wall 111 of the container body 102 has a filling port 104 for filling the toner container 100 with toner. The filling port 104 has a circular shape. The toner cartridge 11 has a cap 150 that closes the filling port 104 after the toner is filled.

The toner container 100 rotatably houses both the paddle 120 and the auger 130 around the longitudinal direction of the toner container 100. The auger 130 is positioned along the toner discharge portion 103. The paddle 120 is located at a substantially central portion of the toner container 100.

The paddle 120 includes a rotation shaft 121 and a stirring blade 122. The paddle 120 rotates about the rotation shaft 121 to stir the toner inside the toner container 100 by the stirring blade 122. The paddle 120 rotates counterclockwise when viewed from the front.

The auger 130 includes a rotation shaft 131 and screw blades 132. The screw blades 132 extend spirally around the rotation shaft 131. The auger 130 rotates about the rotation shaft 131 to convey the toner existing between the screw blades 132 toward the toner discharge portion 103.

The scraping member 140 is cantilevered to one long side of the stirring blade 122 of the paddle 120 extending along the rotation shaft 121 of the paddle 120. The scraping member 140 is an elastic rectangular sheet-like member. The scraping member 140 has a plurality of slits 141. The slits 141 extend perpendicularly to the axis of rotation, from an outer edge towards the paddle 120. As a result of the slits 141, the scraping member 140 has a plurality of scrapers 142 formed between the plurality of slits 141. The plurality of scrapers 142 are deformable independently of each other.

The short side of the scraping member 140 extending perpendicularly to the rotation axis of the paddle 120 has a length enough to hit the inner wall of the toner container 100 and the auger 130 as the paddle 120 rotates. The scraping member 140 moves in contact with the bottom of the inner wall of the toner container 100 as the paddle 120 rotates. As a result, the toner is fed into the auger 130. In addition, the scraping member 140 moves in contact with the side portion and the upper portion of the inner wall of the toner container 100 as the paddle 120 rotates. Accordingly, the scraping member 140 scrapes off the toner adhering to the inner wall of the toner container 100.

The toner cartridge 11 includes a gear unit 160 at the end portion of the toner container 100 on the back side. The gear unit 160 is for rotating the paddle 120 and the auger 130.

The gear unit 160 includes a paddle gear 161 for rotating the paddle 120 and an auger gear 162 for rotating the auger 130. The gear on the outer periphery of the paddle gear 161 and the gear on the outer periphery of the auger 130 are engaged with each other. Therefore, the auger gear 162 rotates in accordance with the rotation of the paddle gear 161.

The paddle gear 161 has a coupling shaft 163 protruding forward along the rotation center of the paddle gear 161. The auger gear 162 has a coupling shaft 164 protruding forward along the rotation center of the auger gear 162.

The front wall 111 of the container body 102 has a bearing portion 115 that bears a front shaft end portion 123 of the rotation shaft 121 of the paddle 120. The back wall 112 of the container body 102 has a hole 105 through which the coupling shaft 163 of the paddle gear 161 passes. Further, the paddle 120 has a coupling portion 124 coaxial with the rotation shaft 121 at a rear end portion thereof. The coupling shaft 163 of the paddle gear 161 passes through the hole 105 and is coupled to the coupling portion 124 of the paddle 120 with a seal ring 165 attached thereto. Thus, the bearing portion 115 and the paddle gear 161 rotatably support the paddle 120.

The container body 102 has a bearing portion (not shown) that bears a front shaft end portion 133 of the rotation shaft 131 of the auger 130 near the toner discharge portion 103. The back wall 112 of the container body 102 has a hole (not shown) through which the coupling shaft 164 of the auger gear 162 passes. Further, the auger 130 has a coupling portion 134 coaxial with the rotation shaft 131 at a rear end portion thereof. The coupling shaft 164 of the auger gear 162 passes through a hole (not shown) in the back wall 112 and is coupled to the coupling portion 134 of the auger 130 in a state where a seal ring 166 is attached. Thus, the bearing portion (not shown) of the container body 102 and the auger gear 162 rotatably support the auger 130.

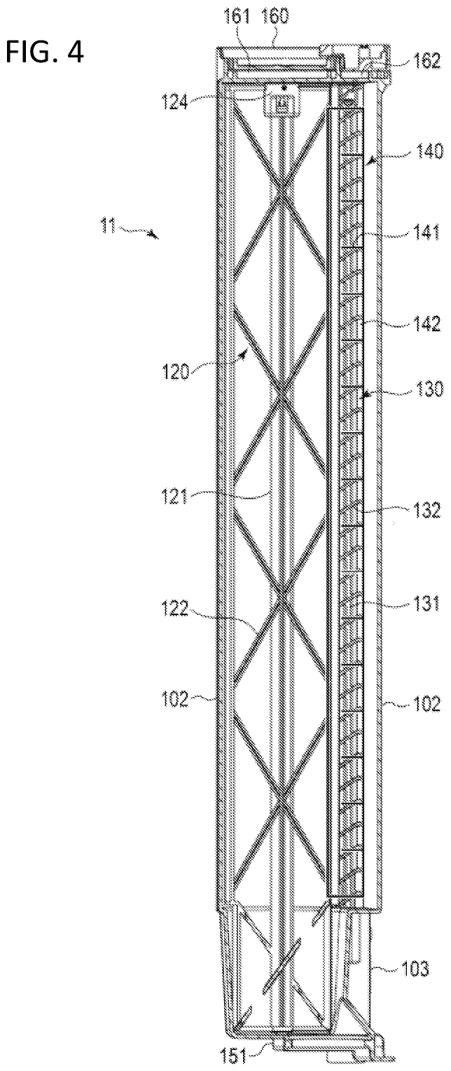

Next, the relationship between the dimensions of the auger 130 and the scraping member 140 will be described with reference to FIG. 4. FIG. 4 is a horizontal cross-sectional view of the toner cartridge 11 in a state in which the scraping member 140 is positioned above the auger 130.

As shown in FIG. 4, the spacing of the slits 141 of the scraping member 140 is equal to or substantially equal to twice the pitch of the screw blades 132 of the auger 130. In other words, the width of the scraper 142 in a direction parallel to the axis of rotation of the paddle 120 is equal to or substantially equal to twice the pitch of the screw blades 132 of the auger 130.

In a conventional scraping member, the spacing of the slits is equal to the pitch of the screw blades of an auger. Compared to such a conventional scraping member, the scraping member 140 of the embodiment has a high rigidity in the vicinity where it is fixed to the paddle 120.

Also, the depth of the slits 141 of the scraping member 140 is deeper than the diameter of the screw blades 132 of the auger 130. In other words, the length of the scraper 142 extending in a direction perpendicular to the axis of rotation of the paddle 120 is greater than the diameter of the screw blades 132 of the auger 130.

Therefore, the scraper 142 of the scraping member 140 can bend and tortionally deform when the paddle 120 rotates and the scraper 142 is in contact with the auger 130. This efficiently feeds the toner into the auger 130.

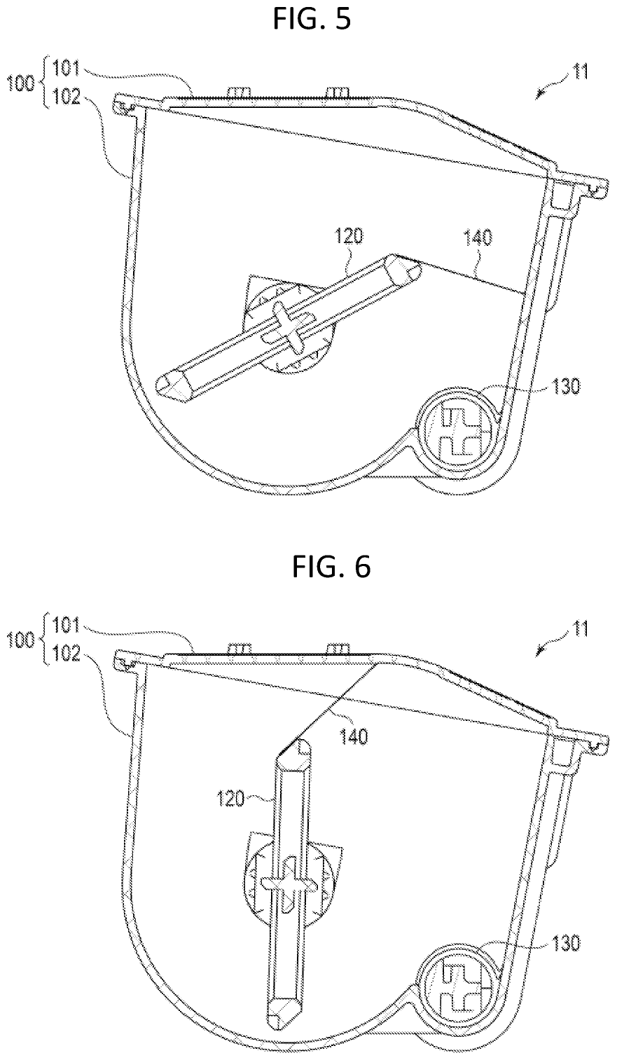

Next, the operation of the scraping member 140 will be described with reference to FIGS. 5 to 8. FIG. 5 to FIG. 8 are vertical cross-sectional views of the toner cartridge 11 in four sequential states according to the rotation of the paddle 120.

As the paddle 120 rotates, the scraping member 140 moves away from the inner wall of the toner container 100, that is, the inner wall of the container body 102, as shown in FIG. 5. The scraping member 140 is in contact with the inner wall of the toner container 100, that is, the inner wall of the container body 102, and the scraping member 140 is curved up to the state shown in FIG. 5 as the paddle 120 rotates. The scraping member 140 scrapes off the toner adhering to the inner wall of the toner container 100 while being curved. In the state of FIG. 5, the scraping member 140, which has been curved so far, is just stretched. Immediately after the state of FIG. 5, the scraping member 140 moves away from the inner wall of the toner container 100, i.e., the inner wall of the container body 102.

That is, immediately before and after the state of FIG. 5, the scraping member 140 elastically expands from the inner wall of the toner container 100, that is, the inner wall of the container body 102. This stretching of the scraping member 140 causes a knocker effect that causes the toner container 100 to vibrate.

After the state of FIG. 5, the scraping member 140 separated from the inner wall of the toner container 100, i.e., the inner wall of the container body 102, enters a state of hitting the inner wall of the toner container 100, i.e., the inner wall of the lid 101, as shown in FIG. 6. During the period from the state of FIG. 5 to the state of FIG. 6 as the paddle 120 rotates, the scraping member 140 is separated from the toner container 100, and the scraping member 140 is extended. When the state shown in FIG. 6 is reached, the scraping member 140 hits the inner wall of the toner container 100, that is, the inner wall of the lid 101.

The impact of the scraping member 140 against the inner wall of the toner container 100, i.e., the inner wall of the lid 101, also causes a knocker effect that causes the toner container 100 to vibrate.

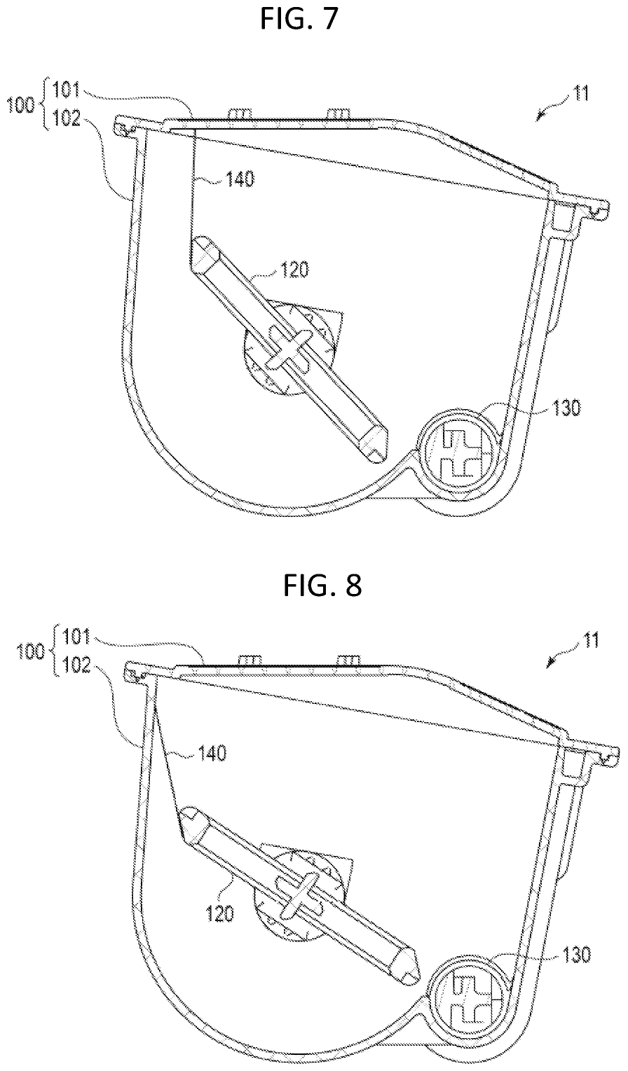

After the state of FIG. 6, the scraping member 140 that has hit the inner wall of the toner container 100, that is, the inner wall of the lid 101 is moved away from the inner wall of the toner container 100, that is, the inner wall of the lid 101, as shown in FIG. 7. During the period from the state of FIG. 6 to the state of FIG. 7 as the paddle 120 rotates, the scraping member 140 is in contact with the inner wall of the toner container 100, that is, the inner wall of the lid 101, and the scraping member 140 is curved. The scraping member 140 scrapes off the toner adhering to the inner wall of the toner container 100 while being curved. In the state of FIG. 7, the scraping member 140, which has been curved so far, is just stretched. Immediately after the state of FIG. 7, the scraping member 140 moves away from the toner container 100.

That is, immediately before and after the state of FIG. 7, the scraping member 140 elastically expands from the inner wall of the toner container 100, that is, the inner wall of the lid 101. This stretching of the scraping member 140 causes a knocker effect that causes the toner container 100 to vibrate.

After the state of FIG. 7, the scraping member 140 separated from the inner wall of the toner container 100, i.e., the inner wall of the lid 101, enters a state of hitting the inner wall of the toner container 100, i.e., the inner wall of the container body 102, as shown in FIG. 8. During the period from the state of FIG. 7 to the state of FIG. 8 as the paddle 120 rotates, the scraping member 140 is separated from the toner container 100, and the scraping member 140 is extended. When the state shown in FIG. 8 is reached, the scraping member 140 hits the inner wall of the toner container 100, that is, the inner wall of the container body 102.

The impact of the scraping member 140 against the inner wall of the toner container 100, i.e., the inner wall of the container body 102, also causes a knocker effect that causes the toner container 100 to vibrate.

After the state of FIG. 8, the scraping member 140 that has hit the inner wall of the toner container 100, that is, the inner wall of the container body 102 is moved away from the inner wall of the toner container 100, that is, the inner wall of the lid 101, as shown in FIG. 5. During the period from the state of FIG. 8 to the state of FIG. 5 as the paddle 120 rotates, the scraping member 140 is in contact with the inner wall of the toner container 100, that is, the inner wall of the container body 102, and the scraping member 140 is curved. The scraping member 140 scrapes off the toner adhering to the inner wall of the toner container 100 while being curved. In the meantime, the scraping member 140 feeds the toner to the auger 130.

As described above, the scraping member 140 scrapes off the toner adhering to the inner wall of the toner container 100 while it is in contact with the inner wall of the toner container 100. In addition, while the paddle 120 rotates one revolution, the two portions inside the toner container 100 are separated from the inner wall of the toner container 100. As a result, the scraping member 140 is stretched twice, and the scraping member 140 hits the inner wall of the toner container 100 twice. Elongation of the scraping member 140 and hitting thereby cause a knocker effect that causes the toner container 100 to vibrate. The knocker effect causes the toner adhering to the inner wall of the toner container 100 to vibrate and fall, thereby preventing the occurrence of a phenomenon in which the toner is compressed into a lump.

As a result, the toner fed into the auger 130 is conveyed to the toner discharge portion 103 by the auger 130 without impairing the fluidity. As a result, the amount of toner remaining in the toner container 100 of the used toner cartridge 11 can be reduced.

As described above, in the scraping member 140 of the embodiment, the distance between the slits 141 is substantially equal to twice the pitch of the screw blades 132 of the auger 130, and the rigidity of the vicinity of the fixed portion with the paddle 120 is higher than that of a conventional scraping member in which the distance between the slits 141 is equal to the pitch of the screw blades 132 of the auger 130. This results in the generation of a high knocker effect.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A toner cartridge for storing toner to be supplied to an image forming apparatus, comprising:
a container in which the toner is stored and including an opening through which the toner is discharged;
a paddle including a plurality of scrapers and configured to rotate inside the container to stir the toner therein; and
an auger including a screw blade and configured to rotate inside the container to feed the toner towards the opening, wherein
each of the scrapers is deformable and extends away from the paddle with respect to a rotation axis of the paddle to contact the auger or an inner wall of the container when the paddle rotates.

2. The toner cartridge according to claim 1, wherein the scrapers are arranged along an outer edge of the paddle and separated from each other by slits.

3. The toner cartridge according to claim 2, wherein an interval of the slits is twice a pitch of the screw blade of the auger.

4. The toner cartridge according to claim 2, wherein a length of the slits is greater than a diameter of the screw blade of the auger.

5. The toner cartridge according to claim 1, wherein the scrapers are deformed when contacting the auger.

6. The toner cartridge according to claim 1, wherein the scrapers are deformed when contacting the inner wall of the container.

7. The toner cartridge according to claim 1, wherein
when the toner cartridge is attached to the image forming apparatus, the auger is located lower than the paddle, and
the scrapers are at a position higher than the auger.

8. The toner cartridge according to claim 1, wherein
the paddle includes a rotation shaft corresponding to the rotation axis thereof and a stirring blade having a rectangular shape, and
the scrapers are attached to a longitudinal side of the stirring blade.

9. The toner cartridge according to claim 1, wherein the inner wall of the container includes a curved portion and a flat portion, a portion of which is in contact with the scrapers.

10. The toner cartridge according to claim 1, wherein the opening is located at a position corresponding to a rotation axis of the auger.

11. An image forming apparatus, comprising:
an image forming unit configured to form an image of toner on a belt;
a fixing device configured to fix on a sheet the image transferred through the belt; and
a toner cartridge including:
a container in which the toner is stored and including an opening through which the toner is discharged,
a paddle including a plurality of scrapers and configured to rotate inside the container to stir the toner therein, and
an auger including a screw blade and configured to rotate inside the container to feed the toner towards the opening, wherein
each of the scrapers is deformable and extends away from the paddle with respect to a rotation axis of the paddle to contact the auger or an inner wall of the container when the paddle rotates.

12. The image forming apparatus according to claim 11, wherein the scrapers are arranged along an outer edge of the paddle and separated from each other by slits.

13. The image forming apparatus according to claim 12, wherein an interval of the slits is twice a pitch of the screw blade of the auger.

14. The image forming apparatus according to claim 12, wherein a length of the slits is greater than a diameter of the screw blade of the auger.

15. The image forming apparatus according to claim 11, wherein the scrapers are deformed when contacting the auger.

16. The image forming apparatus according to claim 11, wherein the scrapers are deformed when contacting the inner wall of the container.

17. The image forming apparatus according to claim 11, wherein
the auger is located lower than the paddle, and
the scrapers are at a position higher than the auger.

18. The image forming apparatus according to claim 11, wherein
the paddle includes a rotation shaft corresponding to the rotation axis thereof and a stirring blade having a rectangular shape, and
the scrapers are attached to a longitudinal side of the stirring blade.

19. The image forming apparatus according to claim 11, wherein the inner wall of the container includes a curved portion and a flat portion, a portion of which is in contact with the scrapers.

20. The image forming apparatus according to claim 11, wherein the opening is located at a position corresponding to a rotation axis of the auger.
